(19) United States
(12) Patent Application Publication
(10) Pub. No.: US 2020/0030966 A1
(43) Pub. Date: Jan. 30, 2020

(54) FOOD COOKING DEVICE

(71) Applicant: KAWASAKI JUKOGYO KABUSHIKI KAISHA, Kobe-shi, Hyogo (JP)

(72) Inventors: Shogo HASEGAWA, Kakogawa-shi (JP); Kazunori HIRATA, Yao-shi (JP); Kentaro AZUMA, Kobe-shi (JP)

(73) Assignee: KAWASAKI JUKOGYO KABUSHIKI KAISHA, Kobe-shi, Hyogo (JP)

(21) Appl. No.: 16/488,169

(22) PCT Filed: Feb. 21, 2018
(86) PCT No.: PCT/JP2018/006319

§ 371 Date: Aug. 22, 2019

Related U.S. Application Data
(60) Provisional application No. 62/461,882, filed on Feb. 22, 2017.

(51) Int. Cl. B25J 9/00; A47J 43/28; B25J 11/00

(52) U.S. Cl. CPC B25J 9/0087; B25J 11/0045; A47J 43/28

(57) ABSTRACT

A food cooking device includes a robot main body having a tray where food is placeable, a spatula configured to move the food in a given direction while contacting the food, a first robotic arm to which the tray is attached, and a second robotic arm to which the spatula is attached, and a control device configured to control operations of the robot main body. The device moves the tray to a given position, while the food is placed on a placement surface of the tray, and sweeps out the food placed on the placement surface of the tray in a direction outward of the placement surface by the spatula.

### TECHNICAL FIELD

The present disclosure relates to a food cooking device.

### BACKGROUND ART

Conventionally, humans have cooked food at a manufacture site of food, such as fast food. In recent years, it is proposed in various fields that a robot and a worker work jointly in the same workspace in terms of an improvement of the productivity.

### DESCRIPTION OF THE DISCLOSURE

### Problems to be Solved by the Disclosure

However, the introduction of the robots has not realized up to now at the manufacture site of food, such as fast food.

The present disclosure is made in view of solving the above problem, and one purpose thereof is to improve the productivity at a manufacture site of food, such as fast food.

### SUMMARY OF THE DISCLOSURE

In order to achieve the purpose, a device according to one aspect of the present disclosure is a food cooking device, which includes a robot main body having a tray where food is placeable, a spatula configured to move the food in a given direction while contacting the food, a first robotic arm to which the tray is attached, and a second robotic arm to which the spatula is attached, and a control device configured to control operations of the first robotic arm and the second robotic arm. The control device controls the operations of the first robotic arm and the second robotic arm to move the tray to a given position, while the food is placed on a placement surface of the tray, and sweep out the food placed on the placement surface of the tray in a direction outward of the placement surface by the spatula.

According to this configuration, a dual-arm robot moves the tray to, for example, above a griddle of a heater or container while patties (food) are placed on the placement surface of the tray. Then, by sweeping out the patties on the tray by the spatula, the patties can be moved on the griddle or into the container.

The control device may control the operations of the first robotic arm and the second robotic arm to, in a state where the placement surface of the tray faces upward, bring the tray closer to the food disposed at the given position, and place, by the spatula, the food on the placement surface of the tray by sending out the food toward the tray.

According to this configuration, the tray is brought closer to the patty (food) which is, for example, cooked on the griddle of the heater, while the placement surface of the tray faces upward. Next, the patty is sent out toward the tray by the spatula at the tip end of the other arm so that the patty can be placed on the placement surface of the tray.

The tray may include a flat-plate part having an placement surface, a peripheral wall provided so as to protrude upwardly in a peripheral edge of the placement surface, and a release part where the peripheral wall does not exist in the peripheral edge of the placement surface. The spatula may include a flat-plate part. The control device may control the operations of the first robotic arm and the second robotic arm to, in a state where the food is placed on the placement surface of the tray, move the tray to a given position, while covering the release part of the tray by the flat-plate part of the spatula.

According to this configuration, since the tray includes the flat-plate part having the placement surface, the peripheral wall provided so as to protrude upwardly in the peripheral edge of the placement surface, and the release part where the peripheral wall does not exist in the peripheral edge of the placement surface, by covering the release part of the tray by the spatula in the state where the patties are placed on the placement surface, the peripheral edge of the placement surface can be covered by the peripheral wall and the spatula. Thus, the patties are prevented from falling out of the tray during patties on the tray are conveyed to above the griddle or the container.

The flat-plate part of the tray may further include a plurality of placement surfaces, and a partition plate provided so as to protrude upwardly at a boundary between adjacent two placement surfaces. The flat-plate part of the spatula may further include a slit formed corresponding to the partition. The control device may control the operations of the first robotic arm and the second robotic arm to sweep out the food placed on the placement surface of the tray by the spatula in a direction outward of the placement surface, while the partition plate of the tray passing through the slit.

According to this configuration, since the flat-plate part of the tray further includes the plurality of placement surfaces, and the partition plate provided so as to protrude upwardly at the boundary between adjacent two placement surfaces, and the flat-plate part of the spatula further includes the slit formed corresponding to the partition, the spatula (flat-plate part) and the tray (partition plate) are avoided from interfering with each other when the food placed on the tray is swept out. The plurality of foods can be swept out on the griddle or the container all at once.

The given position may be a work plane for cooking.

The device may further include an oiling implement configured to be grippable by one of the first robotic arm and the second robotic arm. The work plane for cooking may be a cooking griddle. The oiling implement may include a base, a to-be-gripped part for the robotic arm, provided to the base, a soaking part, provided to the base, and configured to oil the surface of the cooking griddle by soaking the oil at a tip end thereof, and a switching part configured to be changeable of the posture of the tip end of the soaking part with respect to the base.

According to this configuration, for example, when the cooking heater which has upper and lower heating surfaces capable of cooking both sides of the patty (food), by changing the posture of the tip end of the soaking part which soaks oil, both sides of the upper and lower surfaces of the griddle can be oiled.

The device may further include a sprinkler configured to be gripped by one of the first robotic arm and the second robotic arm. The sprinkler may include a base, a to-be-gripped part for the robotic arm, provided to the base, and a container provided to the base and configured to accommodate one of seasoning and cooking ingredient. A plurality of small holes may be formed in a bottom surface of the container.

According to this configuration, since the plurality of small holes are formed in the bottom surface of the sprinkler, when the robot arm holding the sprinkler shakes the sprinkler, a proper quantity of spices accommodated inside the container falls from the small holes formed in the bottom surface, and falls on the cooked patty. The quantity of spice sprinkled over the patty can be adjusted by the number of times of shaking operation.

### Effect of the Disclosure

The present disclosure has the configuration described above and can improve the productivity at the manufacture site of food, such as fast food.

### BRIEF DESCRIPTION OF DRAWINGS

FIG. 1 is a view schematically illustrating a configuration of a robot according to one embodiment of the present disclosure.

FIG. 2 is a view illustrating a 1st use state of a cooking device according to one embodiment of the present disclosure.

FIG. 3 is a view illustrating a 2nd use state of the cooking device.

FIG. 3A is an enlarged view illustrating a part of FIG. 3.

FIG. 4 is a view illustrating a 3rd use state of the cooking device.

FIG. 5 is a view illustrating a 4th use state of the cooking device.

FIG. 6 is a view illustrating a 5th use state of the cooking device.

FIG. 7 is a view illustrating a 6th use state of the cooking device.

FIG. 8 is a view illustrating a 7th use state of the cooking device.

FIG. 9 is a view illustrating an 8th use state of the cooking device.

FIG. 10 is a view illustrating a 9th use state of the cooking device.

FIG. 11 is a view illustrating a 10th use state of the cooking device.

FIG. 12 is a view illustrating an 11th use state of the cooking device.

FIG. 13 is a view illustrating a 12th use state of the cooking device.

FIG. 14 is a view illustrating a 13th use state of the cooking device.

FIG. 15 is a view illustrating a 14th use state of the cooking device.

FIG. 16 is a view illustrating a 15th use state of the cooking device.

FIG. 17 is a view illustrating a 16th use state of the cooking device.

FIG. 18 is a view illustrating a 17th use state of the cooking device.

FIG. 19 is a view illustrating an 18th use state of the cooking device.

FIG. 20 is a view illustrating a 19th use state of the cooking device.

FIG. 21 is a view illustrating a 20th use state of the cooking device.

FIG. 22 is a view illustrating a 21st use state of the cooking device.

FIG. 23 is a view illustrating a 22nd use state of the cooking device.

FIG. 24 is a view illustrating a 23rd use state of the cooking device.

FIG. 25 is a view illustrating a 24th use state of the cooking device.

FIG. 26 is a view illustrating a 25th use state of the cooking device.

FIG. 27 is a view illustrating a configuration of a sprinkler of the cooking device according to a modification of the present disclosure.

FIG. 28 is a view illustrating a use state of the cooking device according to the modification of the present disclosure.

### MODES FOR CARRYING OUT THE DISCLOSURE

Hereinafter, desirable embodiments will be described with reference to the drawings. Note that, in the following, the same or corresponding components are assigned with the same reference characters throughout the drawings to omit redundant description. Moreover, the drawings illustrate each component schematically in order to facilitate understandings. Further, a direction in which a pair of arms is extended is referred to as a left-and-right direction, a direction parallel to an axial center of a base shaft is referred to as an up-and-down direction, and a direction perpendicular to the left-and-right direction and the up-and-down direction is referred to as a front-and-rear direction.

### EMBODIMENT

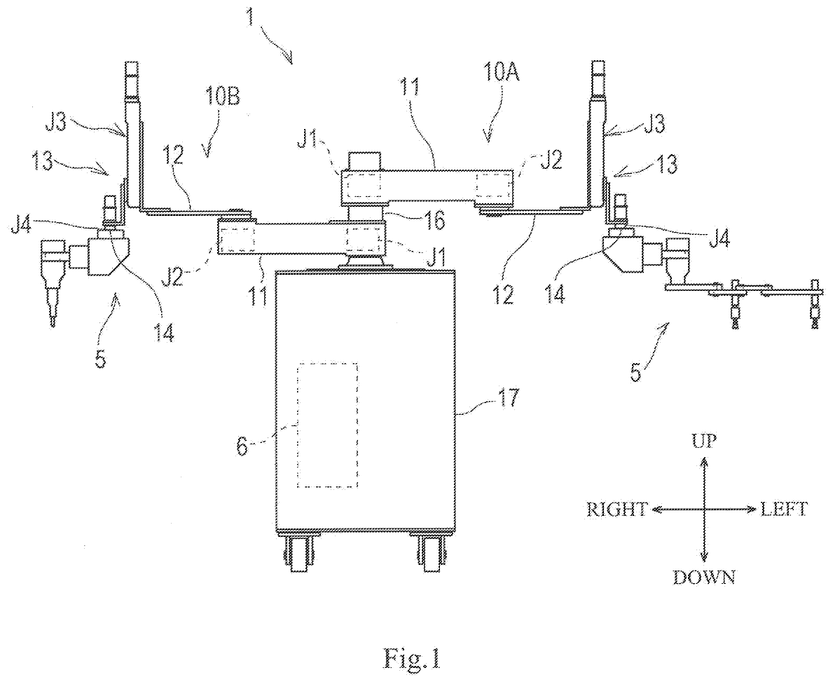

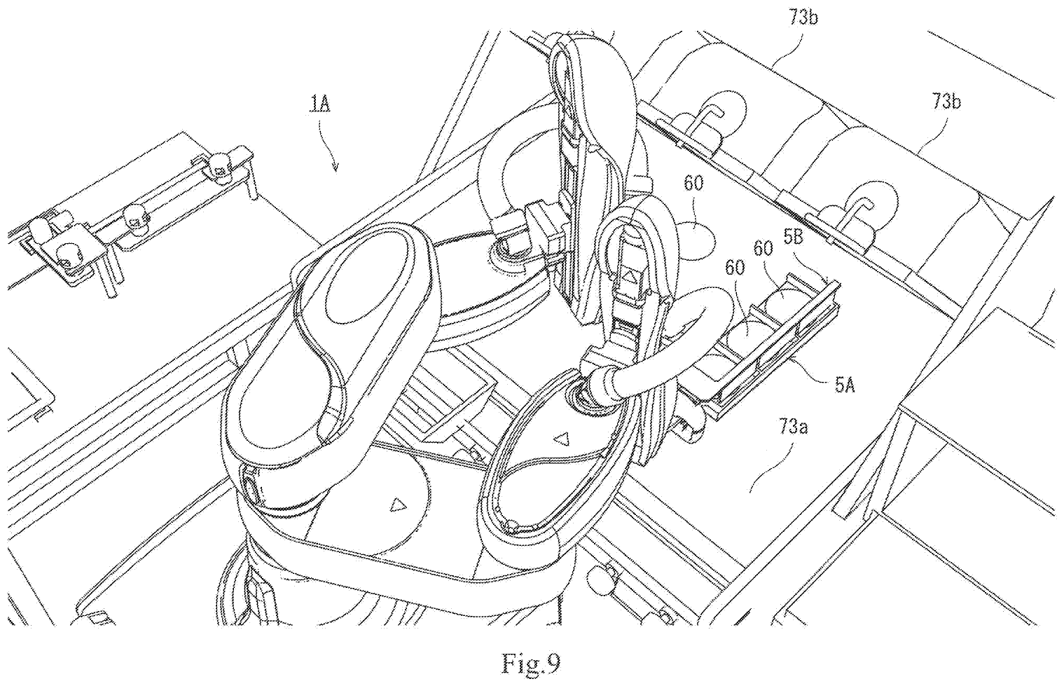

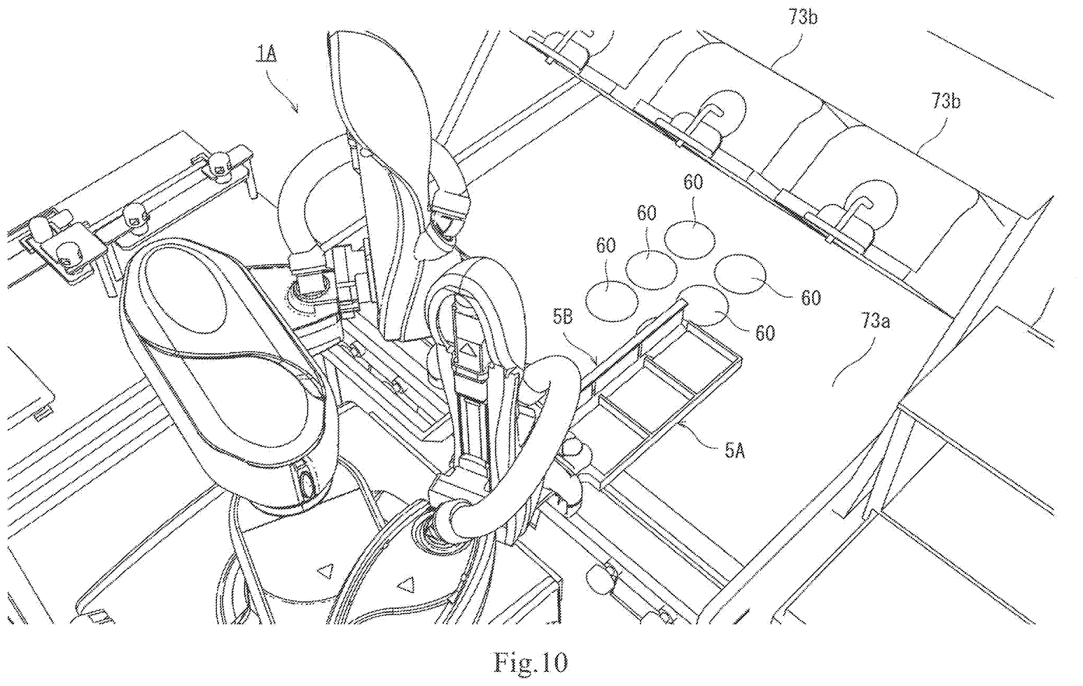

FIGS. 1 to 26 disclose a cooking device which cooks food. This cooking device is provided with a robot. The outline configuration of the robot is illustrated in FIG. 1. The outline configuration of the robot is first described with reference to FIG. 1.

FIG. 1 is a view illustrating an outline configuration of a robot 1 according to one embodiment of the present disclosure. As illustrated in FIG. 1, the robot 1 includes a carriage 17, a pair of robotic arms (hereinafter, simply referred to as the “arms”) 10A and 10B supported by the carriage 17, end effectors 5 attached at tip ends of the respective arms 10A and 10B, and a robot control device 6 which controls operations of the arms 10A and 10B and the end effectors 5.

This robot 1 is a dual-arm robot having the left and right arms 10A and 10B. The left and right arms 10A and 10B are horizontal articulated robotic arms, which can operate independently or dependently.

The left and right aims 10A and 10B have substantially the same structures, and when not distinguishing the left and right arms 10A and 10B one from another, they are indicated by “the arm(s) 10” while omitting the alphabet. Each arm 10 includes a first link 11, a second link 12, and a wrist part 13 having a mechanical interface (hereinafter, may simply be referred to as a to-be-gripped part) 14 to which the end effector 5 is attached, and these components are coupled in series.

The first link 11 is coupled to a base shaft 16 fixed to an upper surface of the carriage 17, through a rotary joint J1. The first link 11 is rotatable about a vertical rotation axis passing through an axial center of the base shaft 16. Moreover, the second link 12 is coupled to a tip end of the first link 11 through a rotary joint J2. The second link 12 is rotatable about a vertical rotation axis defined at a tip end of the first link 11.

The wrist part 13 is coupled to a tip end of the second link 12 through a linear-motion joint J3 and a rotary joint J4. The wrist part 13 is ascendable and descendable with respect to the second link 12 by the linear-motion joint J3. In addition, the wrist part 13 is rotatable about a rotation axis perpendicular to the second link 12 by the rotary joint J4.

The arm 10 of the above configuration has four control axes provided corresponding to the respective joints J1-J4. The arm 10 is provided, corresponding to the respective control axes, with servo motors for drive and encoders which detect rotation angles of the servo motors (none of them is illustrated). Each servo motor is servo-controlled by the robot control device 6 so that the wrist part 13 of the arm 10 moves along a taught path.

The joint J1 of the left arm and the joint J1 of the right arm are coaxial. The end effector 5 is attached to the wrist part 13 of the arm 10. The end effector 5 is gripped by a chuck provided to a tip end of the wrist part 13.

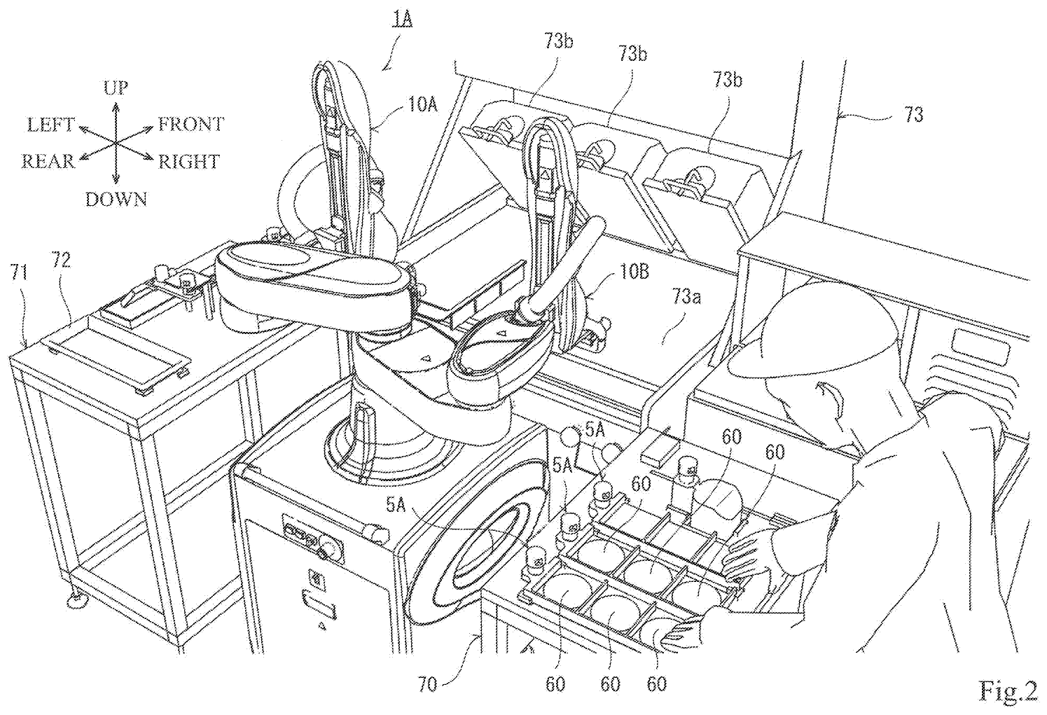

Processes of cooking (e.g., pan fried) patty made from ground meat etc. as one example of the food, by using the cooking device, and use states of the device, will be understood in progress of time by taking a look at FIGS. 2 to 26 in the ascending order of the figures.

Although a robot 1A which constitutes the cooking device illustrated in FIGS. 2 to 26 differs from the robot 1 of FIG. 1 in the detailed shape, the fundamental configuration is the same. However, configurations of the end effectors of FIGS. 2 to 26 gripped by the robot differ from those of FIG. 1.

First, as illustrated in FIG. 2, the dual-arm robot 1A is installed at the center. A right table 70 is placed at the right of the robot 1A, and three tray-type end effectors (hereinafter, simply referred to as the “tray”) 5A are placed on the right table 70. A table 71 is placed also at the left side of the robot, and a dish-like patty container 72 etc. is placed on the table 71. A heater 73 is placed in front of the robot. The heater 73 has a lower heater 73a and upper heaters 73b.

A worker places three disk-shaped patties 60, which are not heated, in line on the tray 5A closest to the viewer of the drawing, and places three more patties 60 in line on the second tray 5A. Each tray is configured so that three patties can be placed thereon in line.

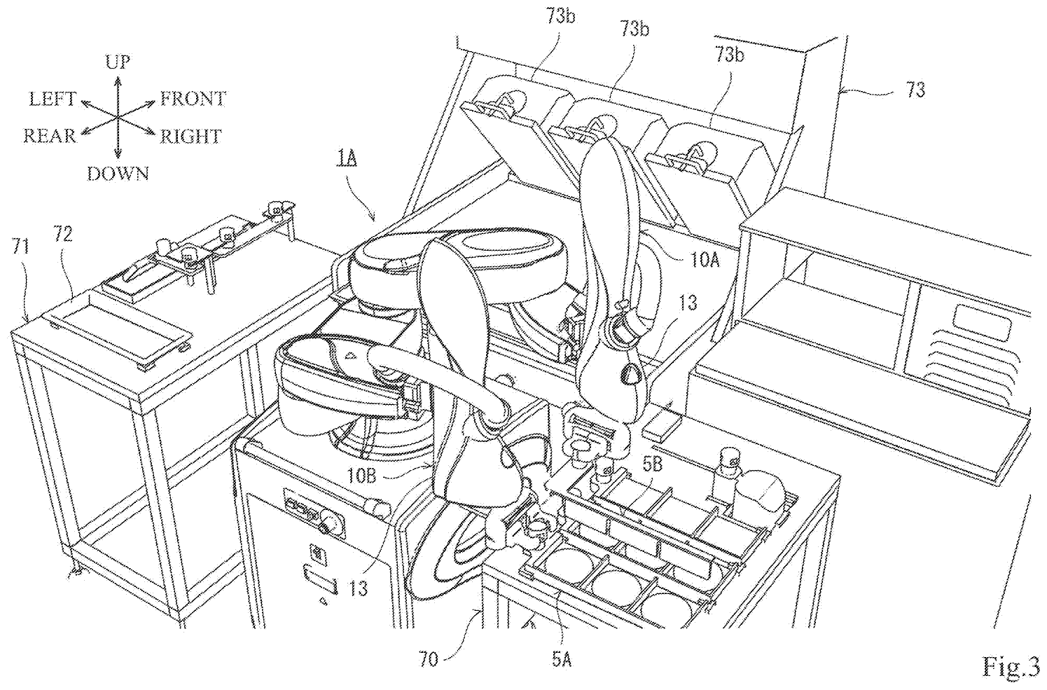

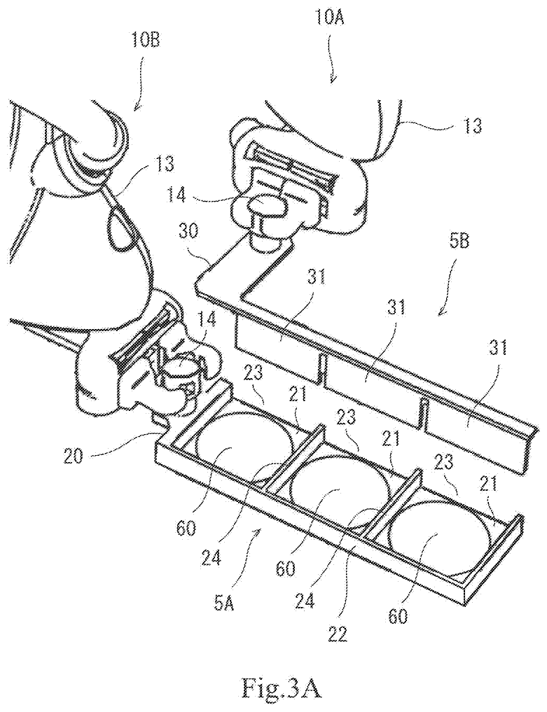

Next, as illustrated in FIG. 3, the dual-arm robot 1A holds the tray 5A closest to the viewer with the right hand, and holds a spatula-type end effector (hereinafter, simply referred to as the “spatula”) 5B with the left hand. In more detail, as illustrated in FIG. 3(A), the tray 5A has a base 20. The to-be-gripped part 14 is provided to the base 20 of the tray 5A, and the right hand grips the to-be-gripped part 14 of the tray 5A. There are three placement surfaces 21 in the tray 5A, where the patties 60 are placed, and a plate-like partition 24 projecting upward is formed at a boundary between the adjacent two placement surfaces 21. Moreover, a peripheral wall 22 is formed in the tray 5A so as to rise upwardly from a peripheral edge in order to prevent the patties 60 from falling out of the peripheral edge of the tray 5A. However, a part of the peripheral edge serves as release parts 23 where the peripheral wall 22 is not formed. The spatula 5B has a base 30 of an L shape in a plan view. The to-be-gripped part 14 is provided to a short-side portion of the base 30 of the spatula 5B, and flat-plate parts 31 are provided to a longitudinal portion. The left hand grips the to-be-gripped part 14 of the spatula 5B. Two rectangular slits 31a are formed in the flat-plate parts 31 of the spatula 5B so as to correspond to the partitions 24 of the tray 5A.

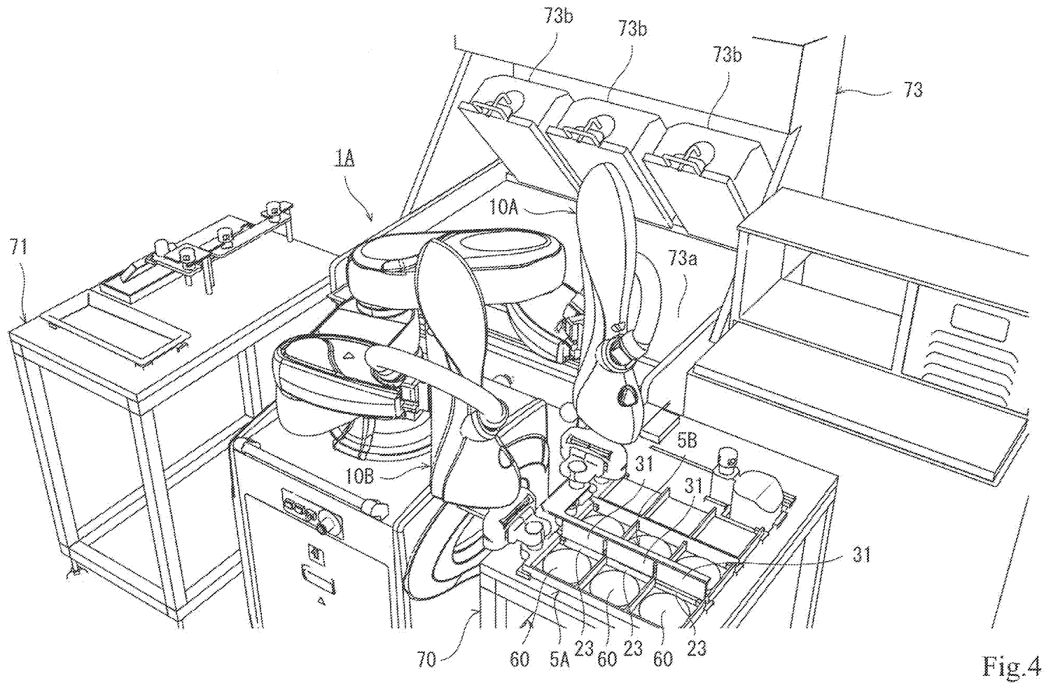

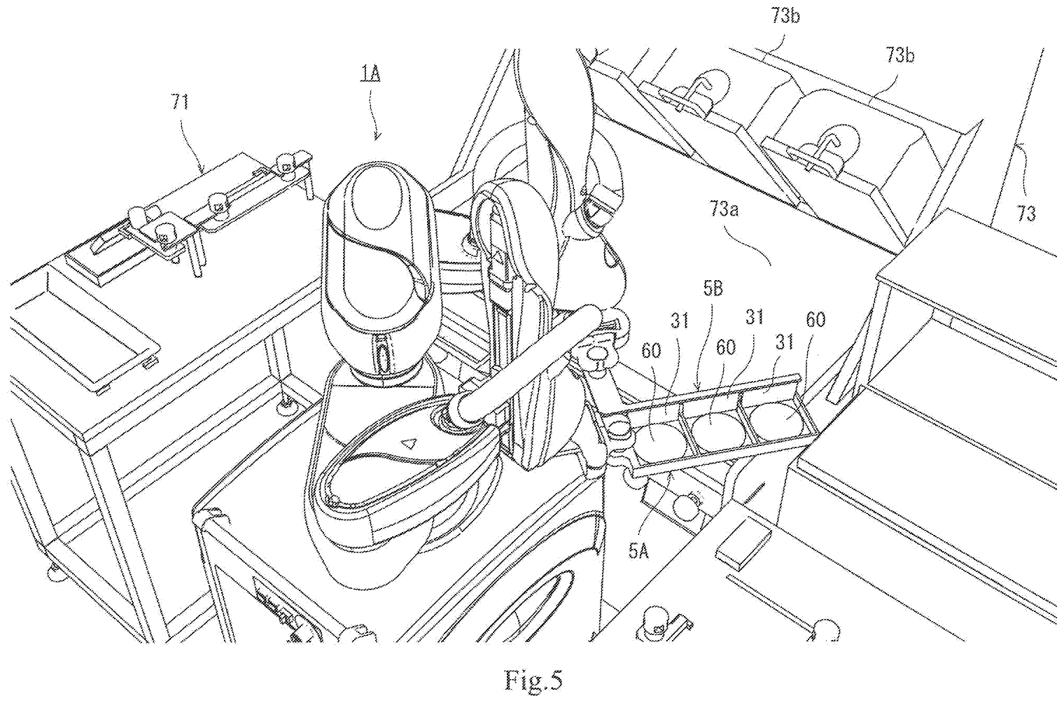

Next, as illustrated in FIGS. 4 and 5, the flat-plate parts 31 of the spatula 5B are brought in contact with the release parts 23 of the tray 5A. Then, the tray 5A and the spatula 5B are moved, while a relative spatial relationship between the tray 5A and the spatula 5B in this state is maintained. Thus, although the patties 60 are moved, since the flat-plate parts 31 of the spatula 5B is in contact with the release parts 23 of the tray 5A, the patties 60 will not fall from the tray 5A during the movement.

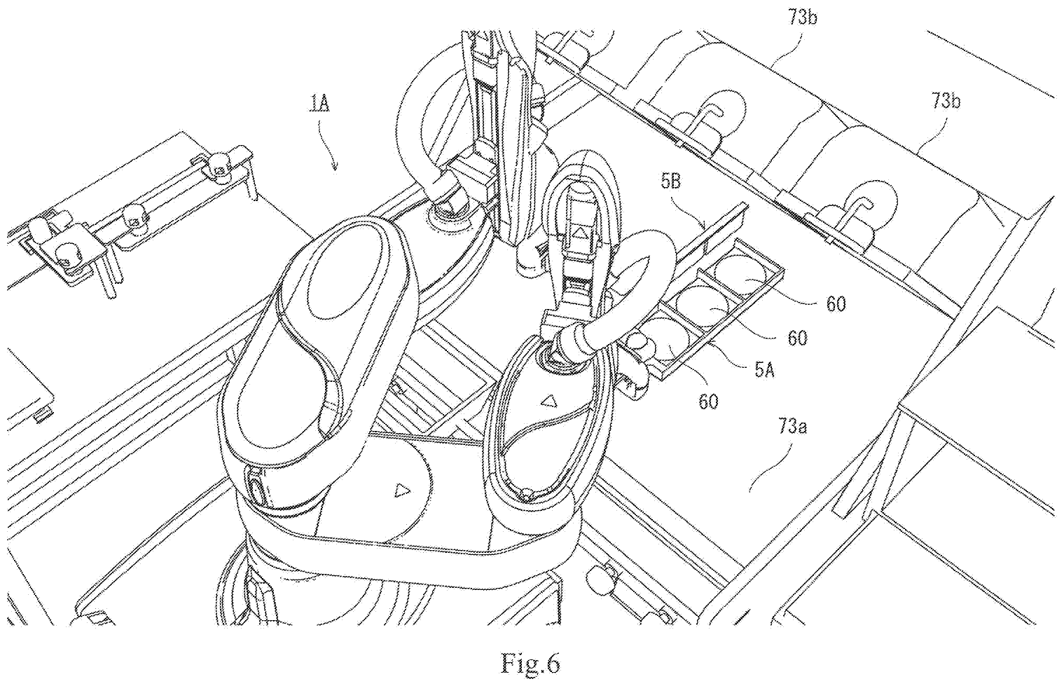

Next, as illustrated in FIG. 6, the tray 5A and the spatula 5B are carried to the lower heater 73a. An upper surface of the lower heater 73a is a heating surface.

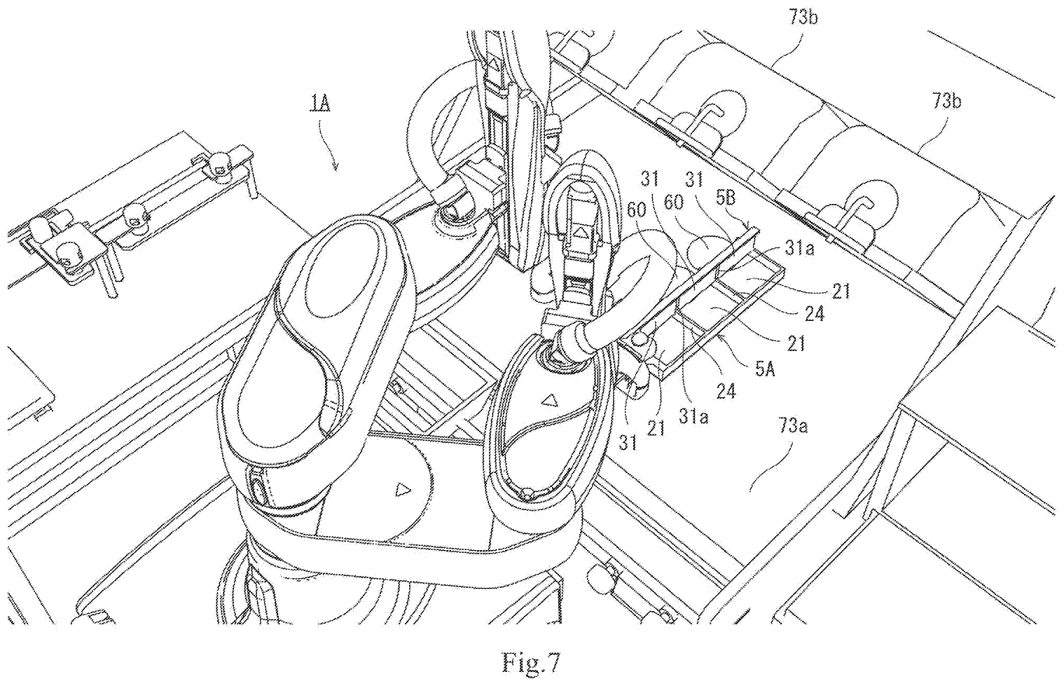

Next, as illustrated in FIG. 7, the patties 60 on the tray 5A is swept out onto the heating surface of the lower heater 73a by using the spatula 5B. Since the slits 31a correspond to the partitions 24, the spatula 5B can be slid in a state where a bottom end of the spatula 5B contacts the placement surface 21 of the tray 5A, or in a state where the bottom end is located near the placement surface 21, to sweep the patties 60 out to the heating surface. The heating surface of the lower heater 73a is comprised of a griddle, and the temperature thereof is maintained at a temperature suitable for cooking the patties 60.

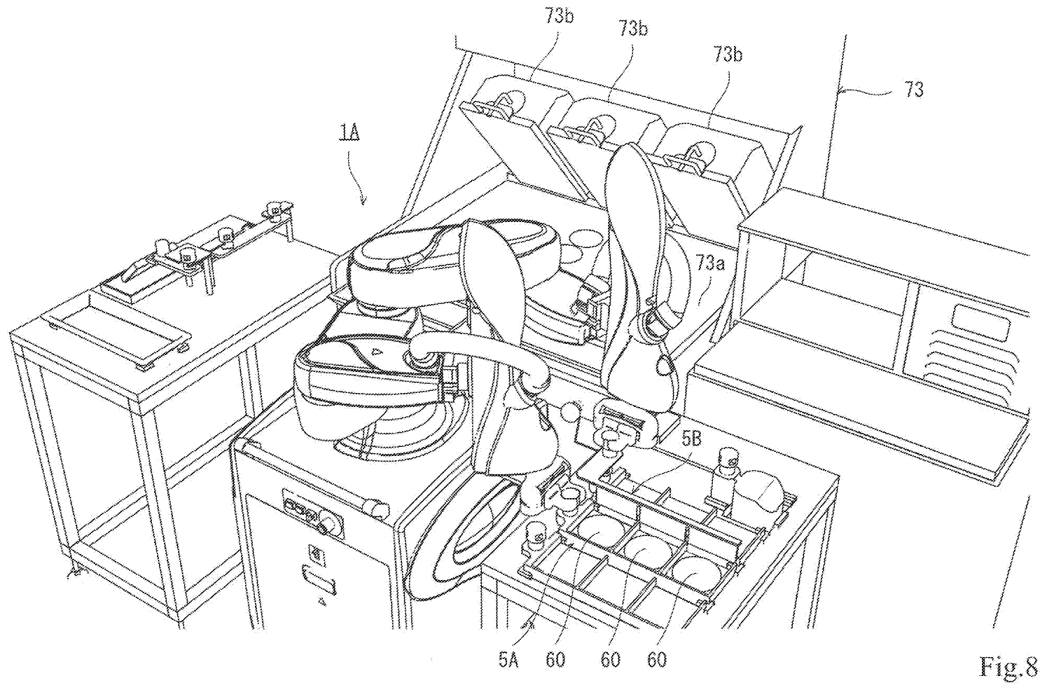

Next, as illustrated in FIGS. 8 to 10, the three patties 60 on the second tray 5A located second closest to the viewer are similarly swept out onto the heating surface from the tray 5A.

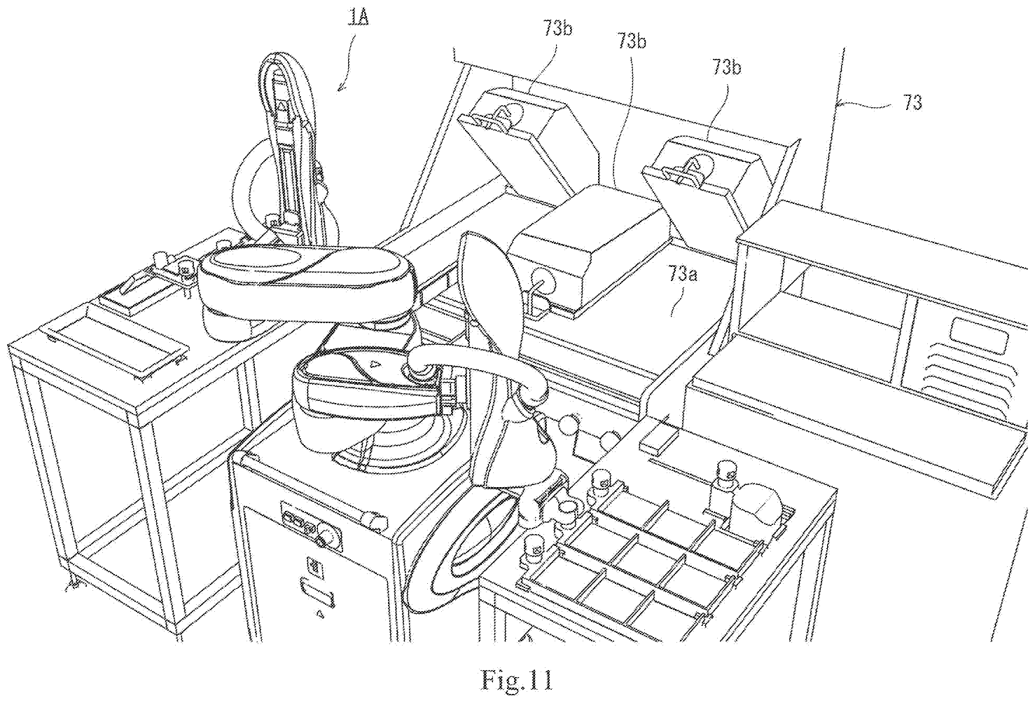

Next, as illustrated in FIG. 11, the upper heater 73b descends toward the lower heater 73a. An undersurface of the upper heater 73b is also a heating surface. This surface is also comprised of a griddle, and the temperature thereof is maintained at a temperature suitable for cooking the patties 60. Thus, the patties 60 are sandwiched between the lower heater 73a and the upper heater 73b, and cooked or pan-flied from the upper side and the lower side. Therefore, it is not necessary to flip the patties 60 over on the heating surface of the lower heater 73a.

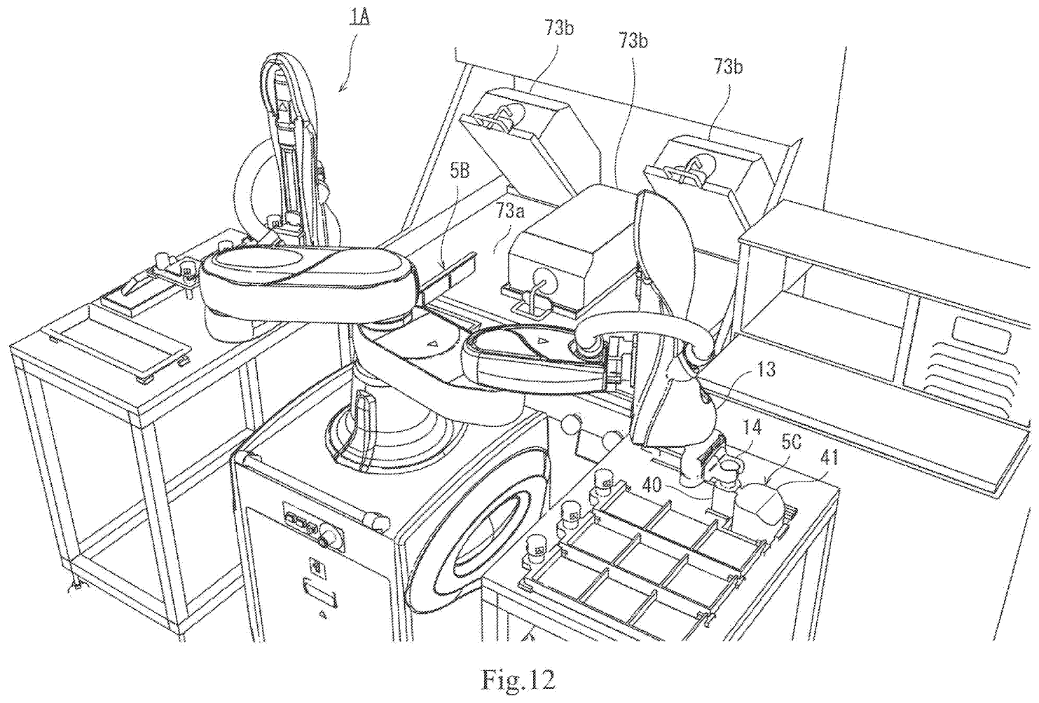

Next, as illustrated in FIG. 12, while the patties 60 are cooked, the right hand of the robot 1A holds an end effector of a sprinkler type (hereinafter, simply referred to as the “sprinkler”) 5C. The sprinkler 5C has a base 40. The to-be-gripped part 14 and a container 41 are attached to the base 40 of the sprinkler 5C. Although the container 41 of the sprinkler 5C can accommodate seasonings, such as spices, or topping ingredients, it accommodates the spices in this example. A plurality of small holes (not illustrated) are formed in a bottom surface of the container 41.

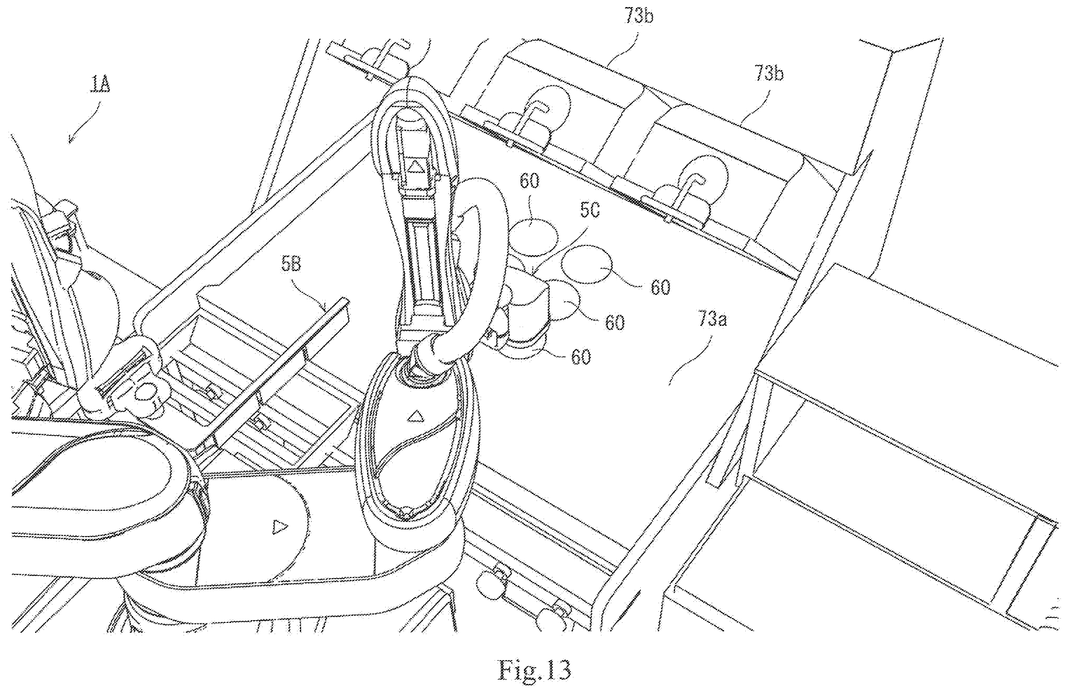

Next, as illustrated in FIG. 13, when the patties 60 are cooked, the upper heater 73b evacuates upwardly. Since the plurality of small holes are formed in the bottom surface of the container 41 of the sprinkler 5C, when the right hand holding the sprinkler 5C shakes the sprinkler 5C, a proper quantity of the spices accommodated inside the container 41 falls from the small holes at the bottom, and falls on the cooked patties 60. The quantity of spices sprinkled over the patties 60 can be adjusted by the number of times of the shakes.

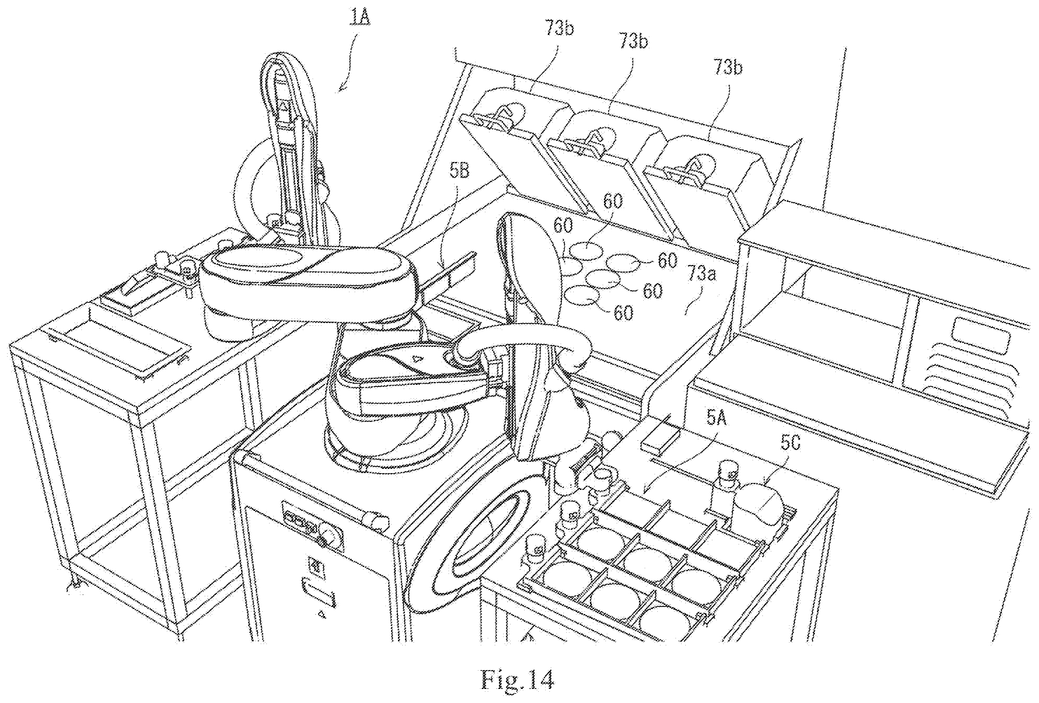

Next, as illustrated in FIG. 14, the right hand holds the tray 5A located third closest to the viewer. The left hand holds the spatula 5B.

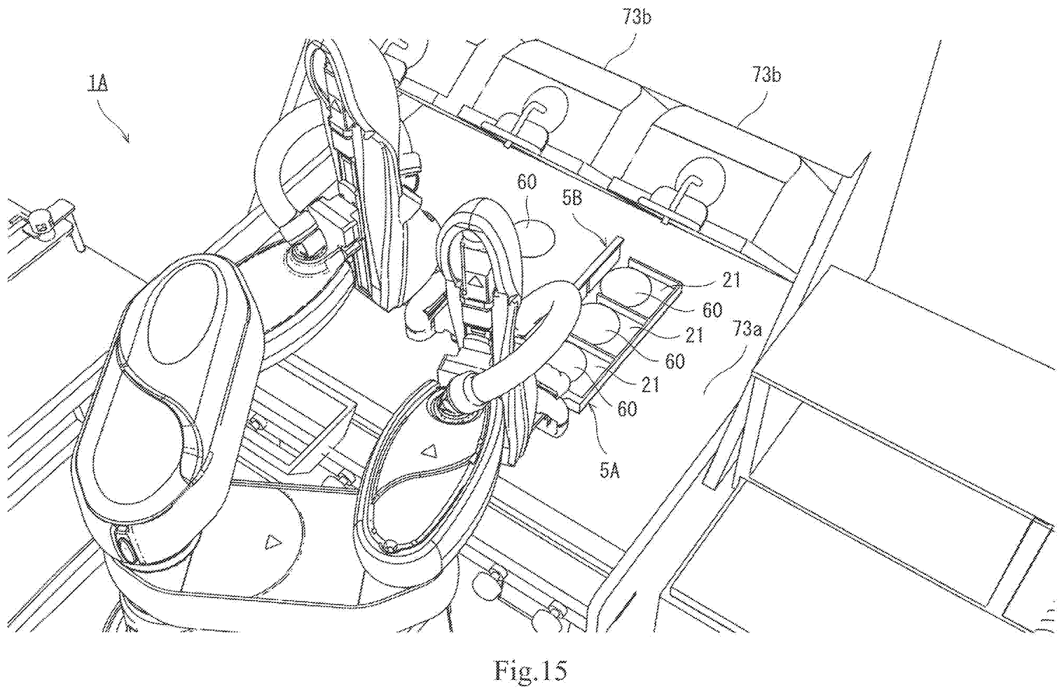

Next, as illustrated in FIG. 15, the three patties 60 on the heating surface of the lower heater 73a are placed on the placement surface 21 of the tray 5A by using the spatula 5B.

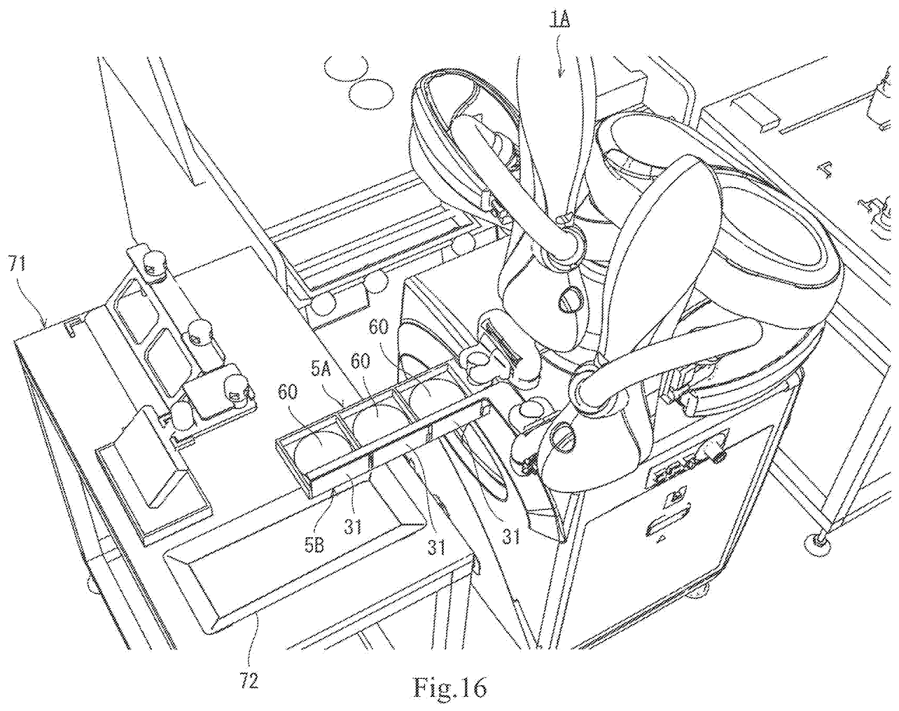

Next, as illustrated in FIG. 16, the spatula 5B is brought in contact with the tray 5A, and the tray 5A and the spatula 5B are then carried to the left table 71. Thus, although the patties 60 are moved, since the flat-plate parts 31 of the spatula 5B contact the release parts 23 of the tray 5A, the patties 60 will not fall from the tray 5A during the movement.

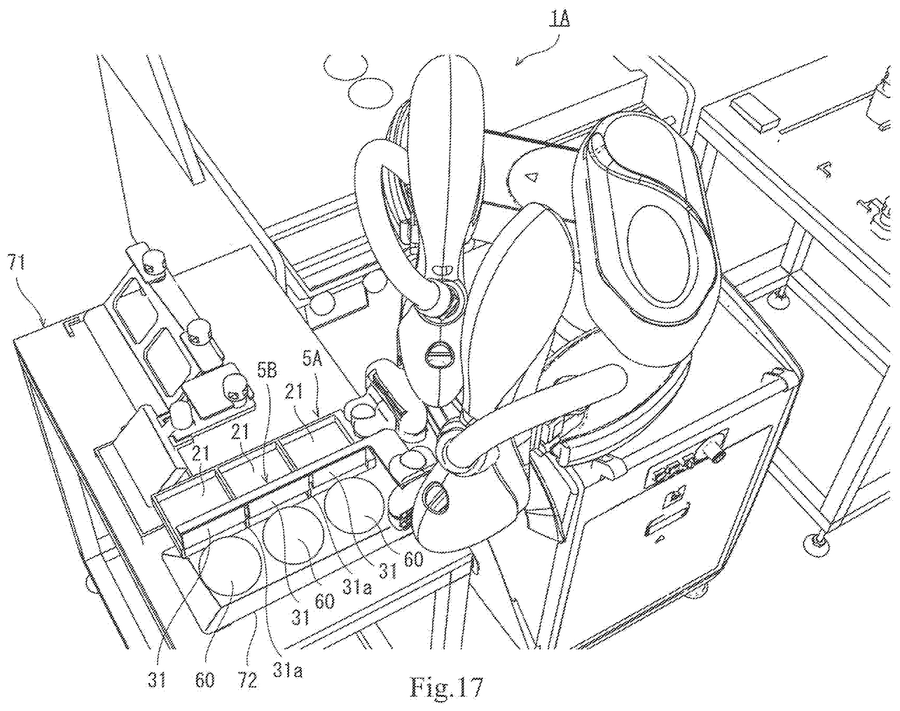

Next, as illustrated in FIG. 17, the patties 60 on the tray 5A are swept out onto the dish-like patty container 72 by using the spatula 5B. Since the slits 31a of the spatula 5B correspond to the partitions 24 of the tray 5A, the spatula 5B can be slid in a state where a bottom part of the spatula 5B contacts the placement surface 21 of the tray 5A, or in a state where the bottom end is located near the placement surface 21, to sweep the patties 60 out to the patty container 72.

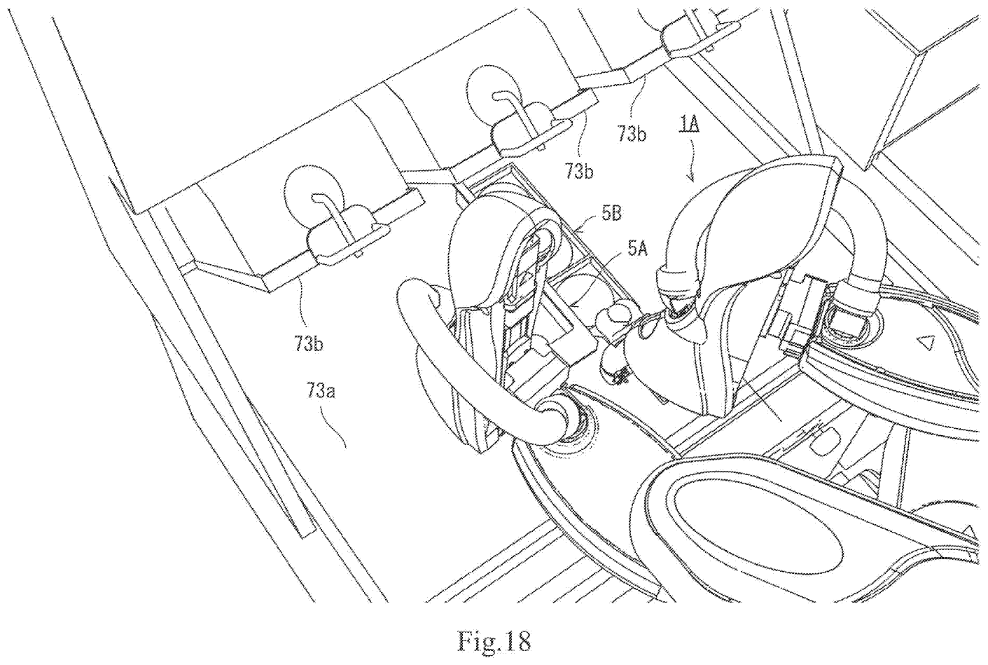

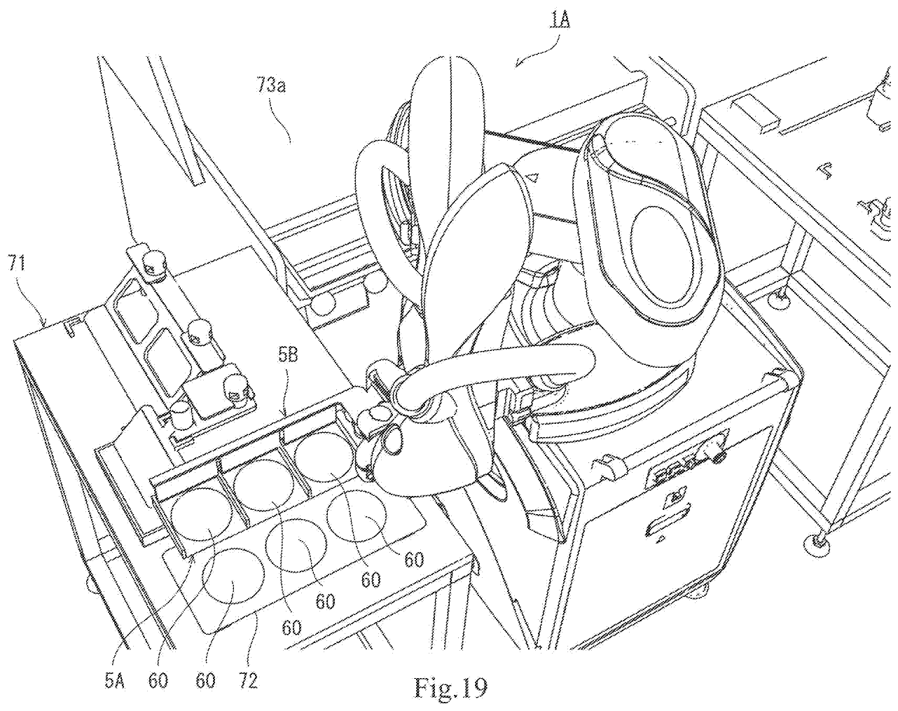

Next, as illustrated in FIGS. 18 and 19, the three patties 60 left behind on the heating surface of the lower heater 73a are similarly swept out onto the patty container 72.

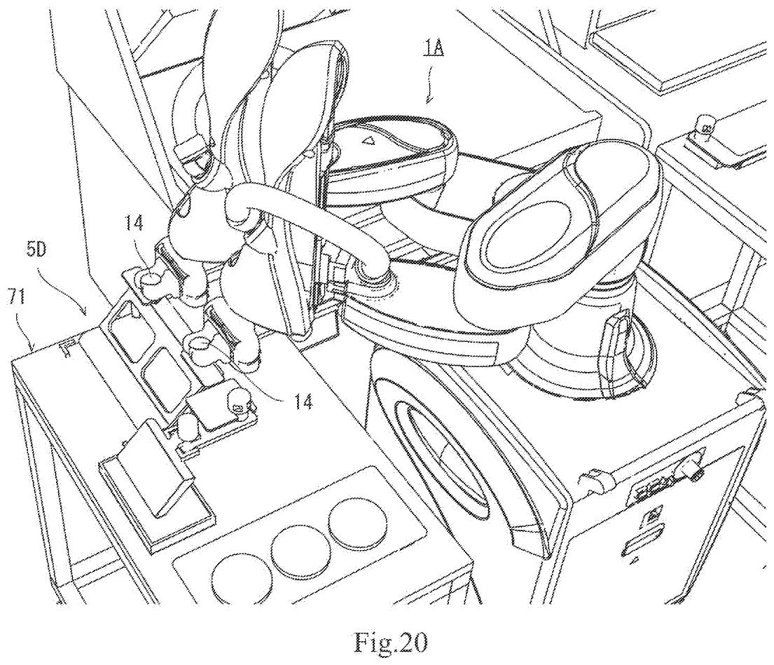

Next, as illustrated in FIG. 20, an end effector 5D of a plate shape for cleaning (hereinafter, simply referred to as the “cleaning plate”) is disposed on the table 71. The robot 1A holds two to-be-gripped parts 14 of the cleaning plate 5D with both the left and right hands.

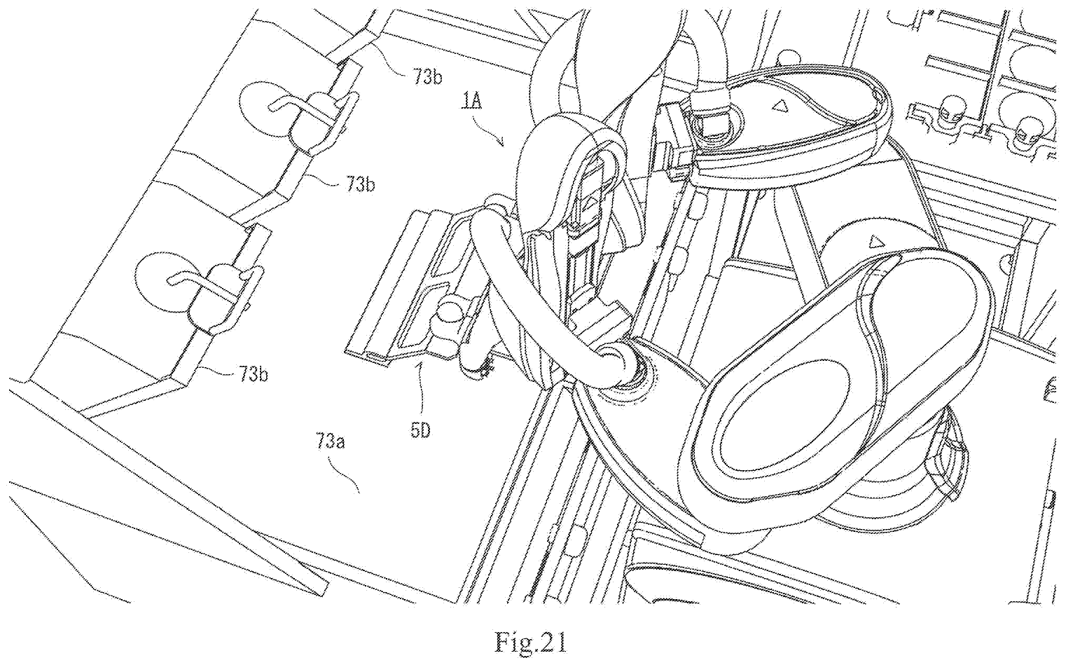

Next, as illustrated in FIG. 21, the waste meat remained on the heating surface of the lower heater 73a, and the waste meat sticking to the heating surface are scraped by the cleaning plate 5D. Thus, the heating surface of the lower heater 73a is cleaned.

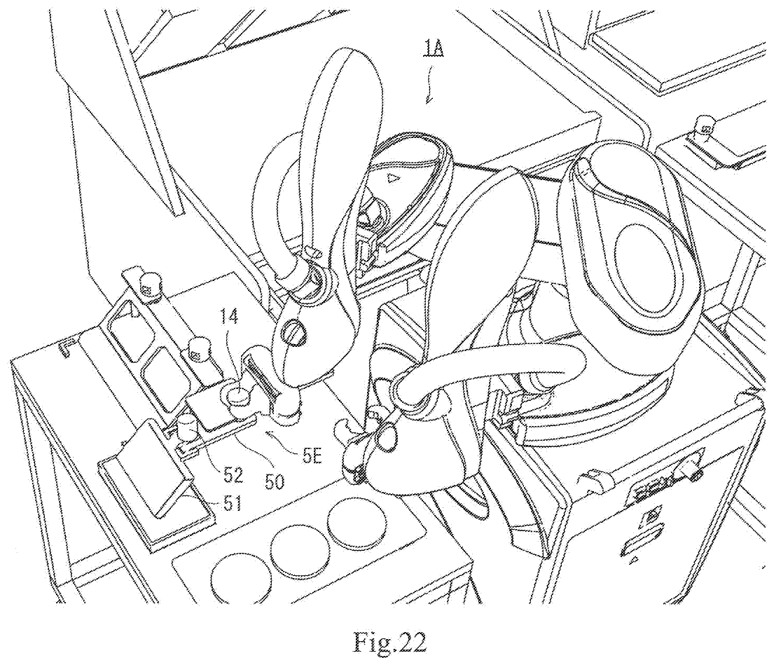

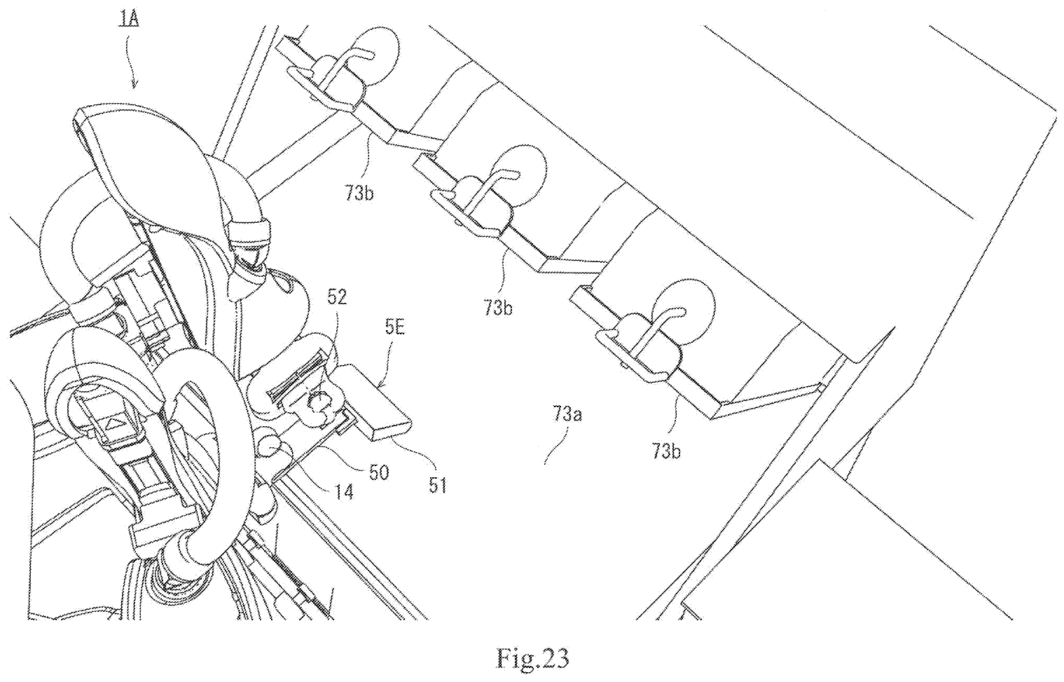

Next, as illustrated in FIGS. 22 and 23, the robot 1A holds an end effector of an oiling implement type (hereinafter, simply referred to as the “oiling implement”) 5E. The to-be-gripped part 14 is provided to the base 50 of the oiling implement 5E, and a switching knob 52 is provided to a position at the tip-end side of the to-be-gripped part 14. A tip-end part of the oiling implement 5E is a soaking part 51 which soaks oil. The posture of the soaking part 51 can be changed by operating the switching knob 52. The right hand of the robot 1A grips the to-be-gripped part 14, and thereby, the oiling implement 5E is held. The left hand grips the switching knob 52. Then, in this state, the oiling implement 5E is conveyed to the heating surface of the lower heater 73a. The soaking part 51 is in a state where it is inclined downwardly.

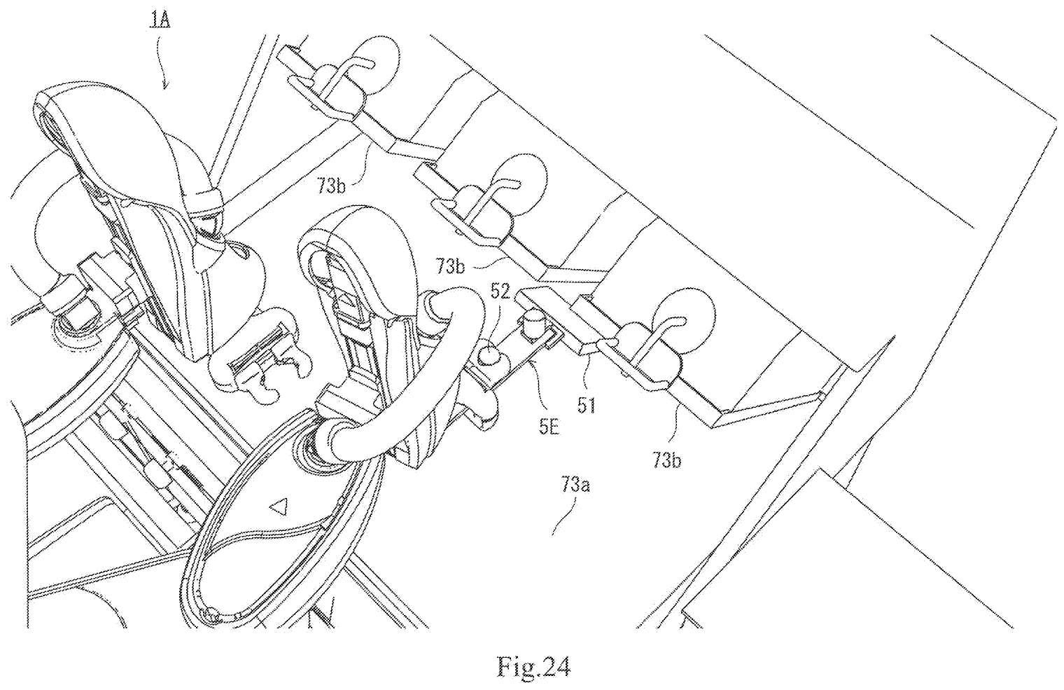

Next, as illustrated in FIG. 24, the robot 1A first oils the heating surface of the lower heater 73a by the oiling implement 5E.

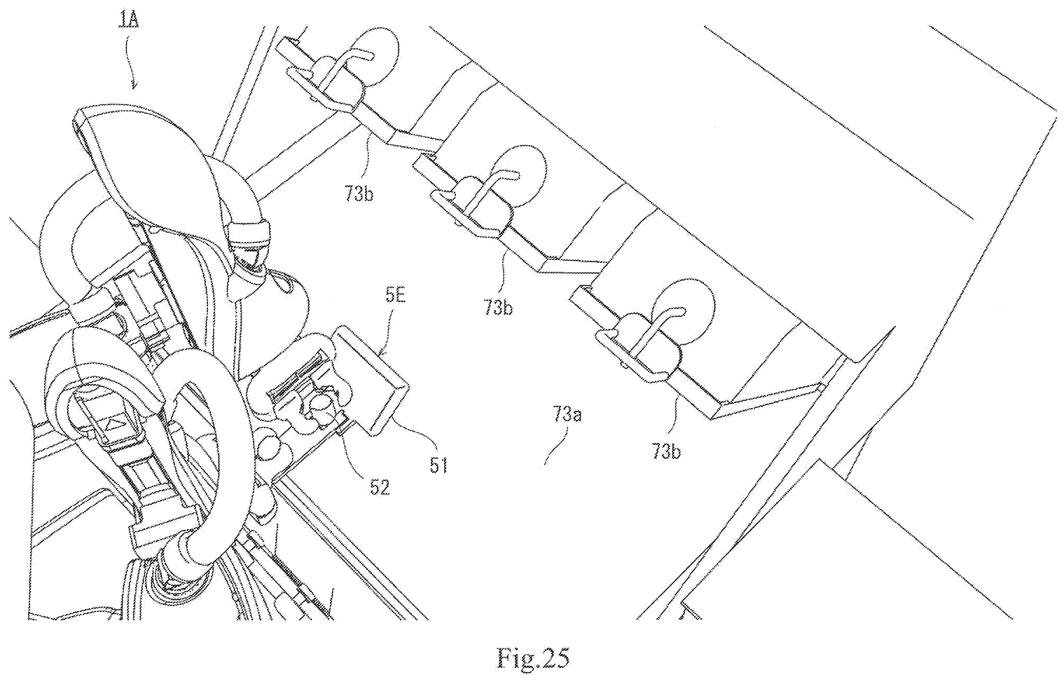

Next, as illustrated in FIG. 25, the left hand operates the switching knob 52 to change the soaking part 51 into a state where it is inclined upward.

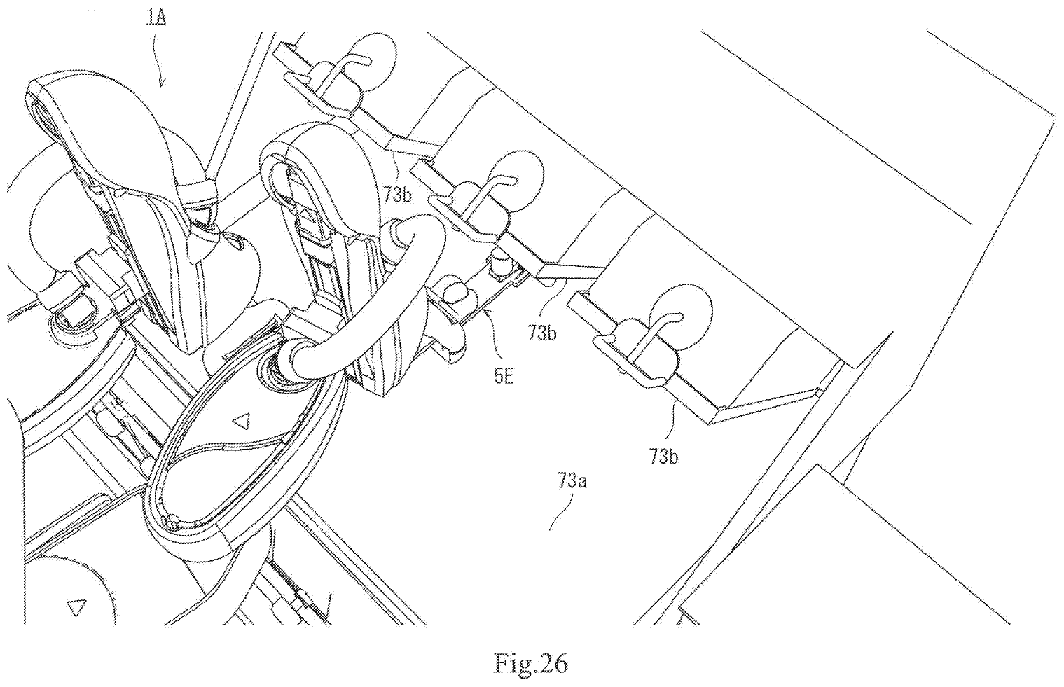

Next, as illustrated in FIG. 26, the robot 1A oils the heating surface of the upper heater 73b by the oiling implement 5E in the state where the soaking part 51 is inclined upward. Thereafter, the robot 1A returns to the state of FIG. 1, and the process to cook the patties is repeated.

As described above, the process to cook the patties is described referring to FIGS. 2 to 26. This device is also capable of cooking other foods, in addition to the patties 60.

Although in FIGS. 2 to 26 the tray 5A having the three placement surfaces 21 is illustrated, the structure of the tray 5A is not limited to this configuration. The tray 5A may have a structure having a plurality of placement surfaces, or only one placement surface. Although the peripheral wall 22 is formed in the tray 5A having only one placement surface, the partitions 24 are not formed. In addition, it is not necessary to form the slits 31a in the flat-plate part 31 of the spatula 5B which is used with the tray 5A having only one placement surface 21.

Moreover, although in FIGS. 2 to 26 the plate-like spatula 5B is illustrated, the shape of the spatula 5B may be any shapes, as long as the shape is suitable for sweeping out the food from the tray 5A, and/or moving the food to the tray 5A from the heating surface. For example, the shape may be a comb shape. The material of the spatula 5B may be a hard material, such as metal, or may be a flexible material, such as resin or plastic.

Moreover, although in the above description the work to cook or pan-fly the patties 60 is described as one example, the present disclosure is not limited to this configuration. The primary inventions will be described below. The first invention is a device and a method in which a work object (in the above description, the patty) is directly gripped and/or sucked, when it is difficult to hold the work object, the work object is placed on a flat plate or a curved plate (in the above description, the tray) provided with a wall in the perimeter thereof and formed with at least one release part, another wall is formed in the release part (in the above description, the spatula) so that the position of the work object is not deviated due to the acceleration and deceleration during the conveyance, and the work object is thus conveyed. The second invention is a device and a method in which the first arm grips an end effector (in the above description, the sprinkler or the oiling implement), and the second arm operates the same end effector as the first invention, and the work is thus performed. The third invention is a device and a method in which, when two or more work objects are placed on the plate, a further wall (in this description, the partition) is formed on the plate so that the objects do not interfere with each other, openings (in the above description, the slits) are formed for avoiding interferences with the further wall on the plate formed in the another wall (in the above description, the spatula) which assists placing the objects onto the plate and assists moving the objects to the placing part from the plate, and the objects are thus held and conveyed. In the present disclosure, inventions with features exist other than the inventions described above.

### Modifications

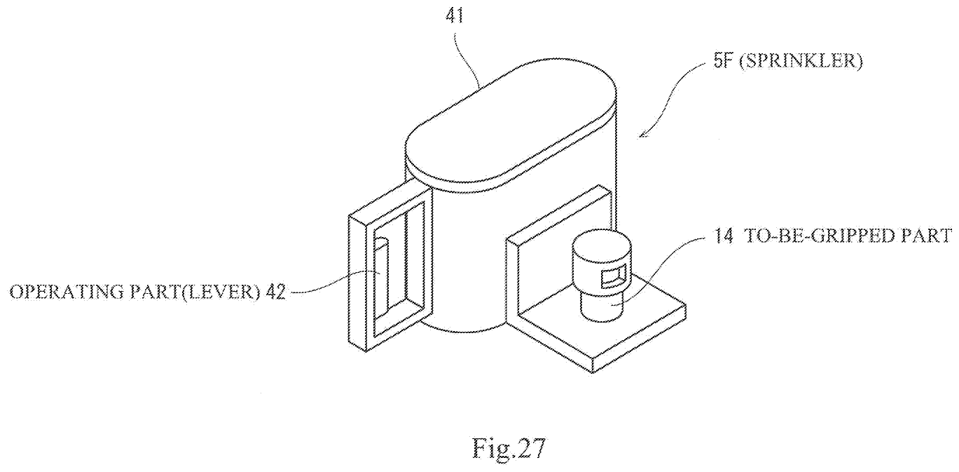

Note that a sprinkler 5F may have a structure where the to-be-gripped part 14 and an operating part (lever) 42 are provided, as illustrated in FIG. 27. The right hand grips the to-be-gripped part 14, and therefore, the sprinkler 5F is held. When the left hand grips the operating part 42 and operates the operating part 42 once, a proper quantity of spices accommodated inside the container 41 falls from the plurality of small holes formed in the bottom surface of the container 41 of the sprinkler 5F, and falls on the cooked patty 60. The quantity of spice sprinkled over the patty 60 can be adjusted by the number of times of operation of the operating part 42.

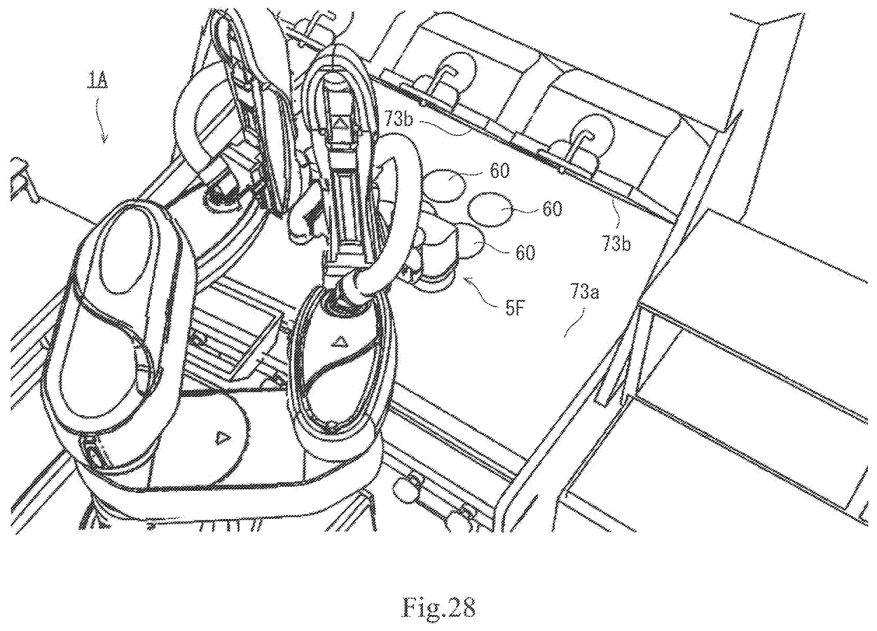

FIG. 28 illustrates a state where the robot 1A sprinkles spices on the cooked patty 60 by using the sprinkler 5F illustrated in FIG. 27. The robot 1A grips the to-be-gripped part 14 by the right hand to hold the sprinkler 5F, and grips the operating part (lever) 42 by the left hand to operate the sprinkler.

It is apparent for a person skilled in the art from the above description that many improvements and other embodiments of the present disclosure are possible. Therefore, the above description is to be interpreted only as illustration, and it is provided in order to teach a person skilled in the art the best mode that implements the present disclosure. The details of the structure and/or the functions may be altered substantially, without departing from the spirit of the present disclosure.

### INDUSTRIAL APPLICABILITY

The present disclosure is useful at the manufacture site of food, such as fast food.

### DESCRIPTION OF REFERENCE CHARACTERS

1, 1A Robot
5, 5A, 5B, 5C, 5D, 5E, 5F End Effector
6 Control Device
10A, 10B Robotic Arm
11 First Link
12 Second Link
13 Wrist Part
14 To-be-gripped Part (Mechanical Interface)
20 Base (Tray Part)
21 Placement Surface
22 Peripheral Wall
23 Release Part
24 Partition Plate
30 Base (Spatula)
31 Flat-plate Part
31a Slit
40 Base (Sprinkler)
41 Container
42 Operating Part
50 Base (Oiling Implement)
51 Soaking Part
52 Switching Knob
60 Patty
70, 71 Table
72 Container

1. A food cooking device, comprising:
a robot main body having a tray where food is placeable, a spatula configured to move the food in a given direction while contacting the food, a first robotic arm to which the tray is attached, and a second robotic arm to which the spatula is attached; and
a control device configured to control operations of the first robotic arm and the second robotic arm,
wherein the control device controls the operations of the first robotic arm and the second robotic arm to:
move the tray to a given position, while the food is placed on a placement surface of the tray, and
sweep out the food placed on the placement surface of the tray in a direction outward of the placement surface by the spatula.

2. The device of claim 1, wherein the control device controls the operations of the first robotic arm and the second robotic arm to:
in a state where the placement surface of the tray faces upward, bring the tray closer to the food disposed at the given position, and
place, by the spatula, the food on the placement surface of the tray by sending out the food toward the tray.

3. The device of claim 1, wherein the tray includes a flat-plate part having a placement surface, a peripheral wall provided so as to protrude upwardly in a peripheral edge of the placement surface, and a release part where the peripheral wall does not exist in the peripheral edge of the placement surface,
wherein the spatula includes a flat-plate part, and
wherein the control device controls the operations of the first robotic arm and the second robotic arm to:
in a state where the food is placed on the placement surface of the tray, move the tray to a given position, while covering the release part of the tray by the flat-plate part of the spatula.

4. The device of claim 1, wherein the flat-plate part of the tray further includes a plurality of placement surfaces, and a partition plate provided so as to protrude upwardly at a boundary between adjacent two placement surfaces,
wherein the flat-plate part of the spatula further includes a slit formed corresponding to the partition, and
wherein the control device controls the operations of the first robotic arm and the second robotic arm to:
sweep out the food placed on the placement surface of the tray by the spatula in a direction outward of the placement surface, while the partition plate of the tray passing through the slit.

5. The device of claim 1, wherein the given position is a work plane for cooking.

6. The device of claim 5, further comprising an oiling implement configured to be grippable by one of the first robotic arm and the second robotic arm,
wherein the work plane for cooking is a cooking griddle, and
wherein the oiling implement includes:
a base;
a to-be-gripped part for the robotic arm, provided to the base;
a soaking part, provided to the base, and configured to oil the surface of the cooking griddle by soaking the oil at a tip end thereof; and
a switching part configured to be changeable of the posture of the tip end of the soaking part with respect to the base.

7. The device of claim 1, further comprising a sprinkler configured to be gripped by one of the first robotic arm and the second robotic arm,
wherein the sprinkler includes:
a base;
a to-be-gripped part for the robotic arm, provided to the base; and
a container provided to the base and configured to accommodate one of seasoning and cooking ingredient,
wherein a plurality of small holes are formed in a bottom surface of the container.

8. The device of claim 2, wherein the tray includes a flat-plate part having a placement surface, a peripheral wall provided so as to protrude upwardly in a peripheral edge of the placement surface, and a release part where the peripheral wall does not exist in the peripheral edge of the placement surface,
wherein the spatula includes a flat-plate part, and
wherein the control device controls the operations of the first robotic arm and the second robotic arm to:
in a state where the food is placed on the placement surface of the tray, move the tray to a given position, while covering the release part of the tray by the flat-plate part of the spatula.

9. The device of claim 2, wherein the flat-plate part of the tray further includes a plurality of placement surfaces, and a partition plate provided so as to protrude upwardly at a boundary between adjacent two placement surfaces,
wherein the flat-plate part of the spatula further includes a slit formed corresponding to the partition, and
wherein the control device controls the operations of the first robotic arm and the second robotic arm to:
sweep out the food placed on the placement surface of the tray by the spatula in a direction outward of the placement surface, while the partition plate of the tray passing through the slit.

10. The device of claim 3, wherein the flat-plate part of the tray further includes a plurality of placement surfaces, and a partition plate provided so as to protrude upwardly at a boundary between adjacent two placement surfaces,
wherein the flat-plate part of the spatula further includes a slit formed corresponding to the partition, and
wherein the control device controls the operations of the first robotic arm and the second robotic arm to:
sweep out the food placed on the placement surface of the tray by the spatula in a direction outward of the placement surface, while the partition plate of the tray passing through the slit.

11. The device of claim 2, further comprising a sprinkler configured to be gripped by one of the first robotic arm and the second robotic arm,
wherein the sprinkler includes:
a base;
a to-be-gripped part for the robotic arm, provided to the base; and
a container provided to the base and configured to accommodate one of seasoning and cooking ingredient,
wherein a plurality of small holes are formed in a bottom surface of the container.

12. The device of claim 3, further comprising a sprinkler configured to be gripped by one of the first robotic arm and the second robotic arm,
wherein the sprinkler includes:
a base;
a to-be-gripped part for the robotic arm, provided to the base; and
a container provided to the base and configured to accommodate one of seasoning and cooking ingredient,
wherein a plurality of small holes are formed in a bottom surface of the container.

13. The device of claim 4, further comprising a sprinkler configured to be gripped by one of the first robotic arm and the second robotic arm,
wherein the sprinkler includes:
a base;
a to-be-gripped part for the robotic arm, provided to the base; and
a container provided to the base and configured to accommodate one of seasoning and cooking ingredient,
wherein a plurality of small holes are formed in a bottom surface of the container.

14. The device of claim 5, further comprising a sprinkler configured to be gripped by one of the first robotic arm and the second robotic arm,
wherein the sprinkler includes:
a base;
a to-be-gripped part for the robotic arm, provided to the base; and
a container provided to the base and configured to accommodate one of seasoning and cooking ingredient,
wherein a plurality of small holes are formed in a bottom surface of the container.

15. The device of claim 6, further comprising a sprinkler configured to be gripped by one of the first robotic arm and the second robotic arm,
wherein the sprinkler includes:
a base;
a to-be-gripped part for the robotic arm, provided to the base; and
a container provided to the base and configured to accommodate one of seasoning and cooking ingredient,
wherein a plurality of small holes are formed in a bottom surface of the container.
